(19) United States
(12) Patent Application Publication
(10) Pub. No.: US 2025/0266653 A1
(43) Pub. Date: Aug. 21, 2025

(54) WAVELENGTH-TUNABLE LASER FOR HIGH-AVERAGE POWER

(71) Applicant: Aqwest LLC, Larkspur, CO (US)

(72) Inventor: David M. Filgas, Newbury Park, CA (US)

(73) Assignee: Aqwest LLC, Larkspur, CO (US)

(21) Appl. No.: 19/049,509

(22) Filed: Feb. 10, 2025

Related U.S. Application Data
(60) Provisional application No. 63/630,640, filed on Feb. 20, 2024.

(51) Int. Cl. H01S 3/00; G02F 1/35; G02F 1/39; H01S 3/067; H01S 3/10

(52) U.S. Cl. CPC H01S 3/0092; G02F 1/3528; G02F 1/3544; G02F 1/392; H01S 3/0085; H01S 3/06741; H01S 3/1001

(57) ABSTRACT

The present invention provides a wavelength-tunable laser (WTL) delivering high-average power and/or high-pulse energy that is wavelength-tunable in a continuous manner over larger portions of the visible and/or near-infrared and/or mid-infrared spectra. The WTL uses a laser source at a given wavelength (1ω) generating short, high peak power laser pulses for injecting a photonic crystal fiber (PCF) and for pumping an optical parametric amplifier (OPA). The PCF generates a supercontinuum (SC) seed, which is delivered to the OPA. Phase-matched band of the SC seed is amplified by the OPA to a suitably high level. A delay line may be provided on the 1ω beam to synchronize the SC seed and pump pulses in the OPA. The OPA outputs include the amplified phase-matched band of the SC seed and an OPA idler. Wavelength tuning of the OPA outputs is preferably done by adjusting the angle of propagation in the crystal, which changes the phase matching condition. The 1ω wavelength may be selected from the range from about 1 μm to about 3 μm. In another embodiment, the 1ω wavelength is frequency doubled to 2ω prior to pumping the OPA. In yet another embodiment, the 1ω wavelength is frequency tripled to 3ω prior to pumping the OPA.

### CROSS-REFERENCE TO RELATED APPLICATIONS:

This patent application claims priority from U.S. Provisional Patent Application U.S. Ser. No. 63/630,640, filed on Feb. 24, 2024 and entitled “Wavelength-Tunable Laser for High-Average Power” the entire contents of all of which are hereby expressly incorporated by reference.

### GOVERNMENT RIGHTS IN THIS INVENTION

This invention was reduced to laboratory practice with U.S. Government support under the U.S. Department of Energy grant no. DE-SC0022466. The U.S. Government may have certain rights in this invention.

### FIELD OF THE INVENTION

This invention relates generally to high-average power lasers and high-pulse energy laser, and more specifically to pulsed lasers that are wavelength-tunable in the visible and infrared spectra.

### BACKGROUND OF THE INVENTION

There is a strong need for lasers generating high-average power and/or high-pulse energies that are used in industrial, scientific, and defense applications. Prior art discloses such lasers operating at one or more wavelengths in the visible (VIS) and infrared (IR) spectra. These lasers generate coherent light via lasing various laser gain medium (LGM) including certain solid-state materials, gas, or liquid dyes. Radiation produced by such lasers may be further harmonically converted to other wavelengths. There is also a strong need for lasers delivering high-average power and/or high-pulse energy that are wavelength-tunable in a continuous manner over significant portions of the VIS and/or IR spectra.

Prior art discloses various wavelength-tunable lasers including the titanium-sapphire (TiS) solid-state laser, which can be continuously tuned over the range of about 600-800 nm (and its accompanying harmonics), Co: MgF₂ solid-state laser, which can be continuously tuned in the range of about 1800-2450 nm, thulium-based solid-state laser offering a broad tunability from about 1890 to 2120 nm, praseodymium-based fiber lasers tunable over the range of about 1250-1390 nm, and Coumarin dye laser tunable in the range of about 500-600 nm. Evidently, these prior art lasers have very restricted tuning ranges. In addition, the TiS laser generally has a low efficiency as it requires pumping by another laser. Furthermore, the Co: MgF₂ solid-state laser, praseodymium-based fiber laser, and Coumarin dye laser have not shown the capacity of producing output at high-average power and/or high-pulse energies.

Therefore, there is a strong need for lasers that can efficiently deliver high-average power and/or high-pulse energy while operating at wavelengths not normally or advantageously available from lasing known LGM.

### Supercontinuum (SC) Generation

Supercontinuum (SC) generation is the phenomenon in which a nearly continuous spectrally broadened output is produced through non-linear effects acting at high-peak power in short pulses of coherent light. Such broadened spectra find applications in spectroscopy and hyperspectral imaging. SC generation offers a broadband source from which many wavelength channels can be obtained by slicing the spectrum.

A very convenient technique for SC generation involves injection of high-intensity laser pulses into an optical fiber. The fiber provides a very strong confinement of the laser beam in an extremely small core. Suitably high intensity levels can be maintained over long interaction lengths. The dispersion profile of the fiber can be appropriately tailored by varying the transverse refractive index profile of the fiber. The spectral broadening that occurs in the fiber is attributed to a combination of various non-linear effects such as self-phase modulation, Raman scattering, and alike. In particular, photonic crystal fibers (PCF) achieve single mode guiding over very a wide wavelength spectrum. Engineered dispersion in PCF enables very broad generation of SC with good conversion efficiency. For example, an injection of picosecond laser pulses at near-1 μm wavelength into a highly non-linear PCF may produce coherent light with spectral power densities of up to a few mW/nm and spectral range spanning up to 400-2400 nm. While the energy in an exemplary 1-nm wide portion of the spectrum may be less than a nanojoule, the peak power is about 4 orders of magnitude higher than that of tunable diode sources that have far more limited bandwidths. Similarly, an injection of picosecond laser pulses at near-2 μm wavelength into a highly non-linear PCF may produce coherent light with spectral power densities of up to a few mW/nm and a spectral range spanning up to about 2.8-8 μm. For optimal SC generation, the SC fiber should have a zero-dispersion wavelength that is somewhat shorter than the pump wavelength. Suitable PCF for operating in the visible and near-infrared spectra can be obtained from NKT Photonics Inc. in Boston, MA and from Ideal Photonics in Kwun Tong, Hong Kong. FIG. 1 shows the plot of spectral output of the super compact single mode white light laser using the NKT SC-3.7-975 Photonic Crystal Fibre technology (Ref. NKT product, SuperK-COMPACT-20200520.)

### Optical Parametric Amplification (OPA)

Optical Parametric Amplification (OPA) is an established technology for the generation of wavelengths beyond the reach of traditional laser gain media (LGM) or harmonic conversion. An OPA uses mixing of optical waves in a non-linear (NL) crystal to transfer energy from a pump beam at a shorter wavelength to a signal beam and idler beam at longer wavelengths. The pump wavelength λₚ, signal wavelength λₚ, and idler wavelength λᵢ are related according as: 1/λₚ=1/λₛ+1/λᵢ. Birefringent crystals such as beta barium borate (β-BaB₂O₄) also known as β-BBO, potassium titanyl arsenate (KTiOAsO₄), also known as KTA, or zinc germanium phosphide (ZnGeP₂), also known as ZGP may be used to phase-match beams at the different wavelengths. Crystals with a high non-linear coefficient are preferred to maximize the conversion efficiency. Because high intensities are required for efficient non-linear conversion, the crystals must also have a high threshold for optical damage. OPAs are attractive for applications that require very high gain (up to 100 db or more) and broad tunability. An OPA is preferably operated by seeding it with an input beam at the signal wavelength λₚ or idler wavelength λᵢ. The bandwidth of the signal and idler outputs from the OPA may be narrow-band or relatively broadband depending on the bandwidth of the OPA pump and seed beams and the phase matching bandwidth of the non-linear process. If the phase matching bandwidth is narrower than the bandwidth of the OPA seed beam, only a portion of the spectrum of the seed beam that is phase matched is amplified. For a given pump wavelength λₚ, the signal wavelength λₚ and idler wavelength λᵢ can be tuned by adjusting the angle of propagation in the crystal, or the crystal temperature, or both.

### SUMMARY OF THE INVENTION

The present invention provides a wavelength-tunable laser (WTL) delivering high-average power and/or high-pulse energy that is wavelength-tunable in a continuous manner over large portions of the VIS and/or IR spectra. The WTL of the subject invention uses a laser source generating a beam of short, high-peak power laser pulses. The beam is split into two portions: a first beam portion for injecting a PCF and a second beam portion for pumping an OPA. In response, the PCF produces a SC beam, which is directed to the OPA. The SC beam is provided with energy at a broad range of wavelengths encompassing the OPA signal and/or idler tuning ranges. The OPA then amplifies a spectral portion of the SC beam that is phase-matched to the pump. In this manner, the OPA converts a portion of the pump energy into energy in the signal and/or idler output beams. A delay line may be provided either on the first beam portion or the second beam portion to synchronize the SC seed pulses and pump pulses in the OPA. The OPA signal and idler outputs have wavelengths longer than the pump wavelength. Wavelength tuning of the OPA outputs is preferably accomplished by adjusting the angle of propagation in the crystal, which changes the phase-matching condition. This approach can be generalized using different OPA pump wavelengths to attain various OPA output wavelengths.

A first embodiment of the WTL of the subject invention uses a laser source assembly (LSA) generating a train of short pulses with objective waveform at a fundamental wavelength (1ω). For example, the fundamental wavelength (1ω) may be near −1 micrometer (μm) or near −2 μm. The energy in each pulse of the objective waveform is split in a beam splitter to form a first beam and a second beam. The first beam is injected into a PCF, thereby causing it to produce a SC beam, which is fed as a seed to an OPA. The second beam is used to pump the OPA, which amplifies the phase matched portion of the SC beam, thus yielding a narrower bandwidth signal output and idler output. A delay line may be provided on the first beam or the second beam to allow for the synchronization of the SC beam pulses with the pump pulses within the OPA crystal. Tuning of the signal and idler wavelengths is accomplished by angular adjustment of the OPA crystal. When using a pump with near-1 μm wavelength, this arrangement allows for the generation of coherent output in the signal over the range of approximately 1.4-1.9 μm in the near-infrared (NIR) and of coherent output in the idler over the range of approximately 2.25-3.5 μm in the NIR. Similarly, when using a pump with near-2 μm wavelength, this arrangement allows for the generation of coherent output in the signal over the range of approximately 2.8-3.6 μm in the mid-infrared (MIR) and of coherent output in the idler over the range of approximately 5-8 μm in the MIR.

A second embodiment of the WTL of the subject invention is similar to the first embodiment except that the second beam at 1ω is frequency doubled to 2ω, which is then used to pump the OPA. This arrangement allows for the generation of coherent output in the signal over the range of approximately 650-900 nm in the NIR and coherent output in the idler over the range of approximately 1125-2150 nm in the NIR.)

A third embodiment of the WTL of the subject invention is similar to the first embodiment except that the second beam at 1ω is frequency tripled to 3ω, which is then used to pump the OPA. This arrangement allows for the generation of coherent output in the signal over the range of approximately 480-640 nm in the VIS and coherent output in the idler over the range of approximately 740-832 nm in the NIR.

It is the object of the invention to provide a laser operating at wavelengths not normally or advantageously available from lasing various solid-state materials, gas, or liquid dyes or their various harmonics.

It is another object of the invention to provide an efficient laser that is wavelength-tunable in a continuous manner over a significant portion of the VIS.

It is further object of the invention to provide an efficient laser that is wavelength-tunable in a continuous manner over a significant portion of the near IR spectrum.

It is yet another object of the invention to provide a wavelength-tunable laser delivering high-average power.

It is still another object of the invention to provide a wavelength-tunable laser delivering high-pulse energies.

These and other objects of the present invention will become apparent upon a reading of the following specification and claims.

### BRIEF DESCRIPTION OF THE DRAWINGS

FIG. 1 is a plot of the output spectrum of an exemplary super COMPACT single mode white light laser using NKT Photonic Crystal Fibre technology.

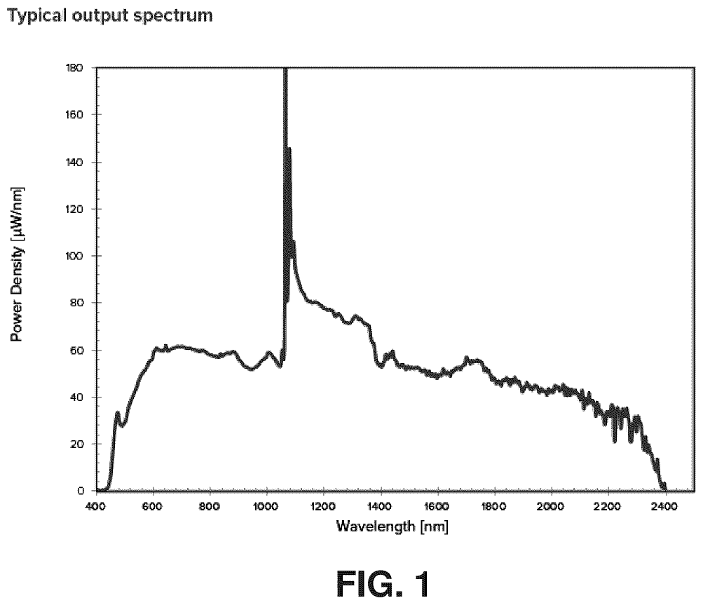

FIG. 2 is a schematic diagram showing the WTL in accordance with a first embodiment of the subject invention.

FIG. 3 is a schematic diagram of the supercontinuum assembly (SCGA) of the subject invention.

FIG. 4 is a schematic diagram of an optical parametric amplifier assembly (OPAA) for use with a first embodiment of the subject invention.

FIG. 5 is a schematic diagram of a possible delay line for synchronization of SC pulse stream and pump pulse stream in the OPA crystal.

FIG. 6 is a schematic diagram showing the WTL in accordance with a second embodiment of the subject invention.

FIG. 7 is a schematic diagram of the harmonic conversion assembly for use with a second embodiment of the subject invention.

FIG. 8 is a schematic diagram of an optical parametric amplifier assembly (OPAA) for use with a second embodiment of the subject invention.

FIG. 9 is a schematic diagram showing the WTL in accordance with a third embodiment of the subject invention.

FIG. 10 is a schematic diagram of the harmonic conversion assembly for use with a third embodiment of the subject invention.

FIG. 11 is a schematic diagram of an optical parametric amplifier assembly (OPAA) for use with a third embodiment of the subject invention.

### DETAILED DESCRIPTION OF THE PREFERRED EMBODIMENTS

Selected embodiments of the present invention will now be explained with reference to drawings. In the drawings, identical components are provided with identical reference symbols in one or more of the figures. It will be apparent to those skilled in the art from this disclosure that the following descriptions of the embodiments of the present invention are merely exemplary in nature and are in no way intended to limit the invention, its application, or uses.

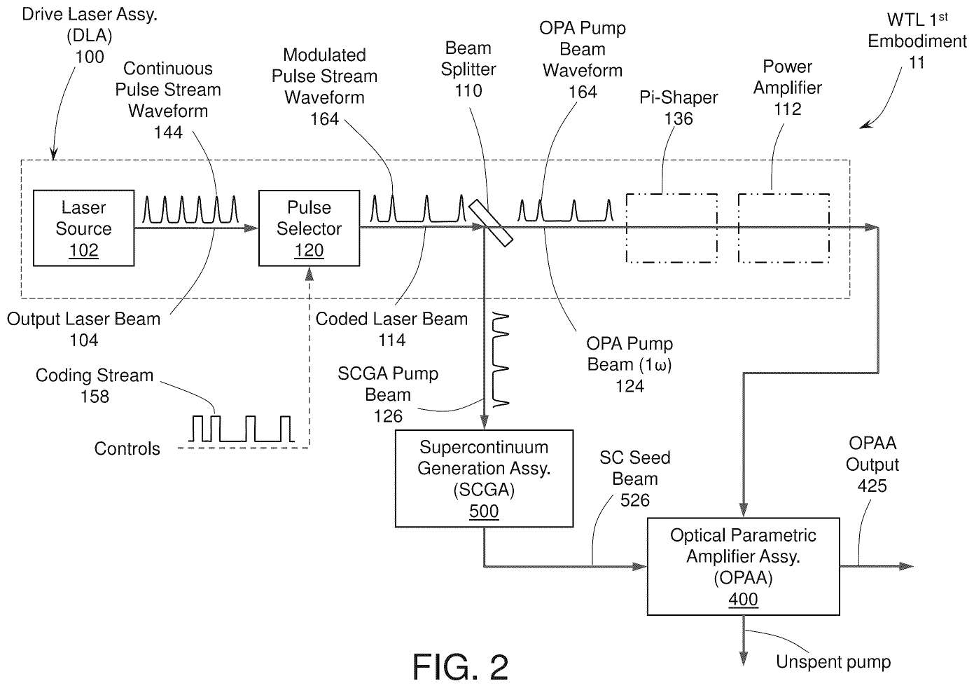

Referring now to FIG. 2, there is shown a wavelength-tunable laser (WTL) 11 in accordance with a first preferred embodiment of the present invention. The WTL 11 generally comprises a drive laser assembly (DLA) 100, supercontinuum generation assembly (SCGA) 500, and optical parametric amplifier assembly (OPAA) 400. The DLA 100 further comprises a source laser 102 and a beam splitter 110. The source laser 102 is arranged to generate an output laser beam 104 at a predetermined wavelength 1ω. The temporal waveform of the laser output beam 104 may be formed as a continuous stream of laser pulses conveyed at a predetermined pulse repetition rate (PRR). Alternatively, the temporal waveform of the output laser beam 104 may be formed as bursts of pulses or as isolated pulses delivered on demand as desired. In one variant of the subject invention, the laser source 102 may generate an output laser beam 104 at a fixed wavelength of 1030 nm (1ω) formed into 20-30 picosecond pulses at 1 megahertz (MHz) pulse repetition rate (PRR) with pulse energy in the range of 10-100 micro-joules (μJ). In another variant of the subject invention, the laser source 102 may generate an output laser beam 104 at a fixed wavelength of 1030 nm or 1064 nm (1ω) formed into 0.5-10 nanosecond pulses at 10 kilohertz (kHz) PRR with pulse energy around 200 μJ. In yet another variant of the subject invention, the laser source 102 may generate an output laser beam 104 at a fixed wavelength near 1900 nm or 2000 nm or 2100 nm (1ω) formed into picosecond to nanosecond-long pulses at 10 to 100 kilohertz (kHz) PRR with pulse energy in the range of 10-100 μJ.

The DLA 100 may also include a pulse selector 120. The pulse selector 120 is an optical modulator device arranged to modulate (switch “on” or “off”, i.e., “select” or “deselect”) a stream of pulses in the output laser beam 104 in accordance with a coding stream 158 provided by the controls (not shown). Selected pulses may continue to propagate on their original path and form a coded beam 114 with modulated pulse stream 164. The pulse selector 120 may be alternatively located in one of the beam paths after the beamsplitter 110. The pulse selector 120 may be an acousto-optical modulator (AOM) or an electro-optical modulator (EOM). Such devices are available commercially. For example, a suitable AOM may be purchased from Isomet Corporation in Manasass, VA. An EOM may be purchased from Thorlabs Inc. in Newton, NJ. The pulse selector may be alternately internal to the laser source 102.

A beam splitter 110 is an optical element arranged to partially transmit and partially reflect incident light at a given wavelength. The beam splitter may be a window made of suitable optical material such as glass, fused silica, or thelike. Its first surface (facing the incoming laser beam) may be uncoated and partially reflect the incoming laser beam by Fresnel reflection. Alternatively, the first surface may be coated to provide partial refection at a predetermined level. In particular, the beam splitter 110 is arranged to largely transmit a portion (for example, 90%) and partially reflect a portion (for example, 10%) of light at the wavelength (1ω) of the laser source 102. The beam splitter 110 may be installed downstream of the pulse selector 120 and arranged to reflect a portion of the laser energy in the pulse stream 164 of the coded laser beam 114. The beam splitter 110 is positioned so that the reflected light forms an SCGA pump beam 126, which is directed to the SCGA 500. A portion of the coded laser beam 114 that is transmitted by the beam splitter 110 forms the OPA pump beam 124 with the modulated pulse stream waveform 164, which is directed to the OPAA 400.

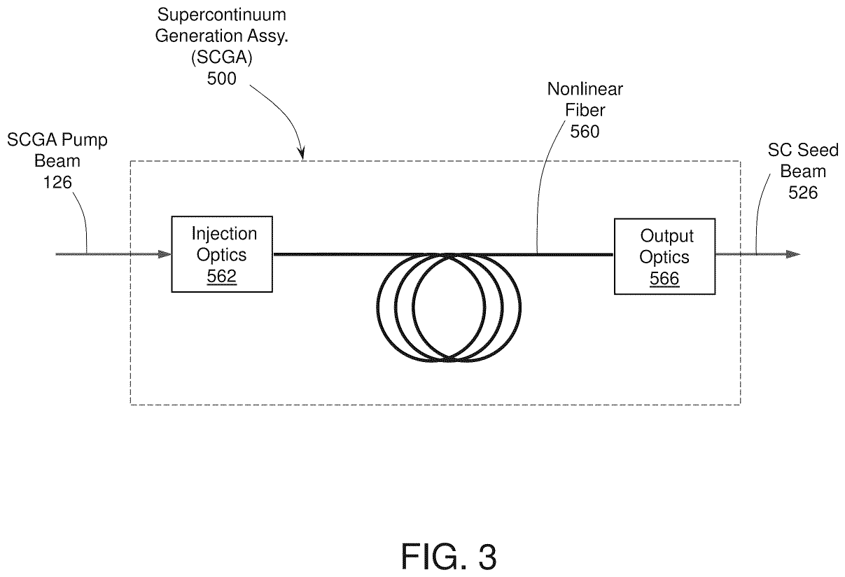

In some variants of the subject invention, the laser source 102 may be sufficiently powerful to simultaneously pump the SCGA 500 and the OPAA 400. In the event more pulse energy is required to pump the OPAA 400, a power amplifier 112 may be added to the DLA 100 as indicated in FIG. 3. The laser gain medium (LGM), (not shown), of the power amplifier 112 may be formed as a fiber, rod, disk, thin disk, slab, thin slab, planar waveguide, and alike. For example, in one preferred embodiment of the subject invention, the output beam of power amplifier 112 may have a pulse energy of about 1 mJ, while in another preferred embodiment of the subject invention, the output beam of power amplifier 112 may have a pulse energy of about 100 mJ.

The OPA pump beam 124 may have a Gaussian spatial profile. In some embodiments of the subject invention, it may be advantageous to convert the spatial profile of the pump beam 124 from a Gaussian to a top-hat (aka, flat-top) spatial profile. In that case, a “Gaussian-to-top-hat spatial profile converter” also known as a Pi-shaper 136 may inserted into the pump beam 124 upstream of the OPAA 400. Preferably, the Pi-shaper 136 is inserted upstream of the power amplifier 112, if used. A suitable Pi-shaper may be obtained from AdlOptica Optical Systems GmbH, in Berlin, Germany.

The SCGA 500 shown schematically in FIG. 3 comprises a non-linear fiber preferably configured as a photonic crystal fiber (PCF) 560, injection optics 562, and output optics 566. The PCF 560 is arranged to receive the SCG pump beam 126 at 1ω via the beam injection optics 562, substantially broaden the spectrum to a supercontinuum (SC), and output the resulting SC seed beam 526 via the output optics 566. The length of the PCF 560 is selected so that a substantial portion of the injected pulse energy is converted to a broad SC. A typical length of the PCF 560 may be a few meters. The SC generation is preferably optimized so that the spectrum of the SC beam 526 encompasses the signal and/or idler wavelength tuning range of the OPAA.

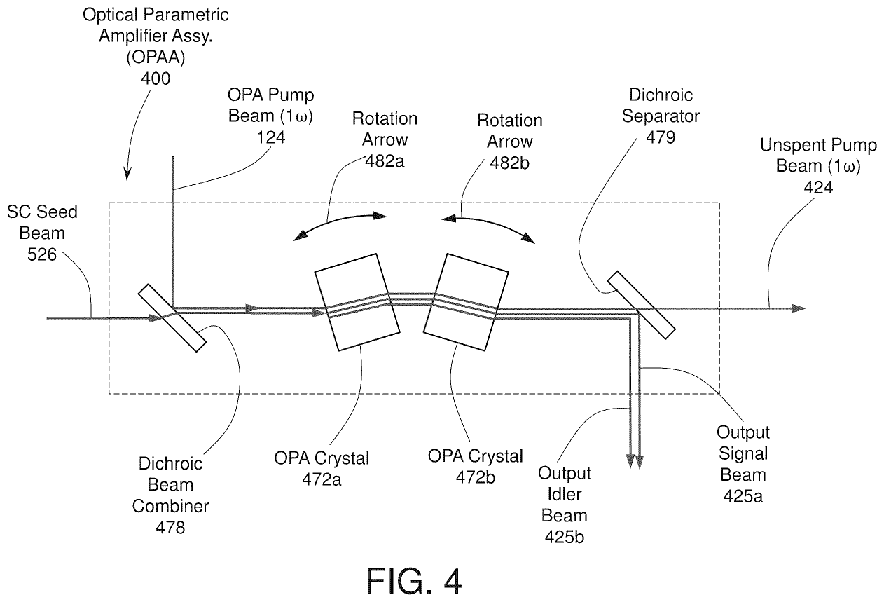

The OPAA 400 shown schematically in FIG. 4 comprises two non-linear crystals 472a and 472b suitable for OPA, a dichroic beam combiner 478, and a dichroic beam splitter 479. The dichroic beam combiner 478 is arranged for combining the SC seed beam 526 and the OPA pump beam 124. The dichroic beam splitter 479 is arranged downstream of the non-linear crystals 472a and 472b. The OPA non-linear crystals are preferably KTA or BBO for operation the visible and NIR wavelength regime or ZGP for operation the MIR wavelength regime. Lengths and cut angles of the non-linear crystals 472a and 472b are preferably set to optimize the generation of targeted OPA output. In particular, the lengths of the non-linear crystals 472a and 472b may not be the same. In some variants of the OPAA 400 where the signal output is preferentially divided, a dichroic filter (not shown) may be placed between the crystals 472a and 472b. Such a dichroic filter may be arranged to transmit light at the pump wavelength λₚ and signal wavelength λₚ while blocking the idler wavelength λᵢ. This approach offers enhanced conversion efficiency by reducing back-conversion in the downstream crystal 472b. Crystal facets that transmit the SC seed beam 526 and the OPA pump beam 124 are equipped with a coating that is antireflective at their desired wavelength and also antireflective at the anticipated OPA signal and idler wavelengths.)

The dichroic beam combiner 478 is adapted for combining the SC seed beam 526 and the OPA pump beam 124. The dichroic beam combiner 478 is preferably equipped with a coating that is highly reflective at the OPA pump wavelength and antireflective at the OPA signal and idler wavelengths. This allows for substantially concentric alignment of the OPA pump beam 124 and the SC seed beam 526, and their collinear injection into the OPA non-linear crystals 472a and 472b. The non-linear crystals 472a and 472b are respectively mounted on opto-mechanical stages that allow the crystals to rotate in a coordinated fashion as indicated by arrows 482a and 482b. During the rotation, the non-linear crystals are rotated in opposite directions to reduce beam walk-off. The rotation changes the phase match inside the non-linear crystals between the OPA pump beam 124 and the SC seed beam 526. In particular, each angular position of the non-linear crystals produces a phase match of the pump to a narrow band of the SC spectrum according to the relation 1/λₚ=1/λₛ+1/λᵢ. Typically, the phase-matched band is about 1 nanometer wide. As the non-linear crystals are rotated, the phase matching condition sweeps over a predetermined spectral portion of the spectrum in the SC seed beam 526. The phase matching condition may be maintained over a non-linear crystal rotation of up to about 7 degrees, which may sweep the OPA output wavelength over the anticipated tuning range of the OPA output. Energy delivered to the non-linear crystals 472a and 472b by the OPA pump beam 124 is transferred to the phase-matched band of the signal and idler beams, and the signal and idler beams are thereby amplified.

The dichroic beam splitter 479 is adapted for separating the signal, idler, and pump beams at the output of the OPA. In particular, the beam splitter 479 is preferably equipped with a coating that is highly transmissive at the OPA pump wavelength and highly reflective at the OPA signal and idler wavelengths. This allows the unspent pump beam 424 to be separated from the signal beam 425a and the idler beam 425b and conveyed to a beam dump (not shown).

When using an OPA pump beam 124 at near-1 μm wavelength, this embodiment allows for the generation of coherent output in the signal beam 425a over the range of approximately 1.4-1.9 μm in the near-infrared (NIR) and of coherent output in the idler beam 425b over the range of approximately 2.25-3.5 μm in the NIR. Similarly, when using an OPA pump beam 124 near-2 μm wavelength, this arrangement allows for the generation of coherent output in the signal beam 425a over the range of approximately 2.8-3.6 μm in the mid-infrared (MIR) and of coherent output in the idler beam 425b over the range of approximately 5-8 μm in the MIR. Either the signal output beam 425a or the idler output beam 425b may be used for the intended application.

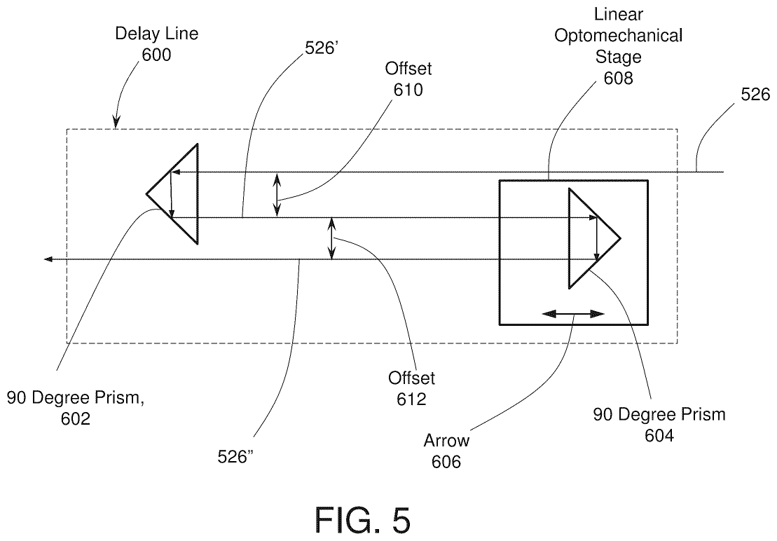

It is preferred, that the arrival of pulses in the beams 526 and 124 in the OPA non-linear crystal is synchronized so that the pulses substantially overlap in time. This may be achieved by the layout of the beamline components. Alternatively, delay means may be installed. The delay means may consist of a delay line 600, for example, in beams 126, 526, or 124. An exemplary delay line 600 is schematically shown in FIG. 5. FIG. 5 shows an exemplary delay line 600, which may be practiced on the SC seed beam 526. The delay line 600 comprises a 90-degree prism 602, which is in a fixed position and a 90-degree prism 604, which is mounted on a linear motion optomechanical stage 608. The linear motion stage is arranged so that its direction of motion identified by the arrow 606 either moves the prism 604 closer to or away from the prism 602. The SCGA pump beam 526 is injected into the prism 602 generally perpendicular to its hypotenuse, enters the prism and undergoes total internal reflections from the two sides of the prism, and departs the prism 602 through its hypotenuse as a beam 526′, which is parallel to the injected beam 526 but displaced from it by a predetermined offset 610. The beam 526′ is then injected into the prism 604 generally perpendicular to its hypotenuse, enters the prism and undergoes total internal reflections from the two sides of the prism, and departs the prism 604 through its hypotenuse as a beam 526″, which is parallel to the injected beam 526′ but displaced from it by an offset 612. By adjusting the position of the linear stage 608, the pathlength traveled by the beam 526 is changed until the pulses delivered to the OPA crystal by the beams 526 and 124 substantially overlap in time. One skilled in the art may readily construct and deploy other suitable variants of the delay line 600 comprising one or more prisms and/or other reflecting means (e.g., mirrors) utilizing an arbitrary number of reflections.

Referring to FIG. 2, in operation, the laser source 102 of DLA 100 generates an output beam 104 comprising a continuous stream of pulses 144 at a predetermined wavelength corresponding to the optical fundamental frequency 1ω. The beam 104 is injected into the pulse selector 120, which modulates the beam in accordance with the coding stream 158 provided from an external source (controls). The pulse selector 120 outputs a coded beam 114 comprising a modulated pulse stream 164 and directs it onto the beam splitter 110. The beam splitter 110 reflects a predetermined portion of incident pulse energy, thus forming the SCGA pump beam 126, and substantially transmits the balance of the pulse energy, thus forming the OPA pump beam 124. The SCGA pump beam 126, which may be substantially monochromatic, is delivered via the injection optics 562 into the non-linear fiber 560 of the SCGA 500 (FIG. 3). The spectrum of the injected pump beam 126 is substantially broadened by the non-linear fiber 560 to a supercontinuum (SC). The resulting SC seed beam 526 departs from the non-linear fiber 560 via output optics 566 and it is directed to the dichroic beam combiner 478 of the OPAA 400 (FIG. 4).

Concurrently, downstream of the beam splitter 110, the OPA pump beam 124 may be reformatted from a Gaussian spatial profile to a flat-top spatial profile in an optional Pi-shaper 136 (FIG. 2) and/or further boosted in pulse energy in an optional power amplifier 112 before it is delivered to the dichroic beam combiner 478 of the OPAA 400 (FIG. 4). Preferably, the SC seed beam 526 and the OPA pump beam 124 are well aligned as they are delivered to the OPA crystals 472a and 472b to substantially overlap in the transverse direction. It is also important that the pulse streams in the SC seed beam 526 and the OPA pump beam 124 are synchronized within the OPA non-linear crystals 472a and 472b so that they substantially overlap in time. Synchronicity may be attained by the layout of optical components in the WTL 11. Alternatively, synchronicity may be attained via a signal delay line such as the delay line 600 shown in FIG. 5, which may be conveniently installed in the path of the beams 124, 126, or 526. As a result, the pulse streams in the SC seed beam 526 and the OPA pump beam 124 significantly overlap in the transverse direction and in the longitudinal direction (i.e., in time) within the OPA non-linear crystals 472a and 472b. For a given crystal angle, a phase match may occur between the optical wave of the OPA pump beam 124 and a narrow spectral portion of the optical wave of the SC seed beam 526. The phase-match may occur at the signal wavelength and at the idler wavelength. Seeding at either the phase-matched signal wavelength and/or at the phase-matched idler wavelength by the broadband SC beam may be adequate to stimulate rapid growth of the narrower bandwidth phase-matched signal and/or idler beams as they propagate through the OPA crystal. Under these conditions, the desired signal band (together with an associated idler wave) will be amplified in the OPA crystals thereby producing the OPA output signal beam 425a. Typical bandwidth of the spectral band may be in the range of 1 nanometer. The center wavelength of the spectral band of the signal beam 425a (and the central wavelength of the associated idler beam 425b) may be wavelength-tuned by changing the crystal angle, e.g., by rotation. If two OPA non-linear crystals 472a and 472b of equal or comparable lengths are used, the crystals may be oriented so that when they are rotated in opposite directions, the birefringent walk-off in crystal 472a is naturally compensated for (at least in part) in the crystal 472b.

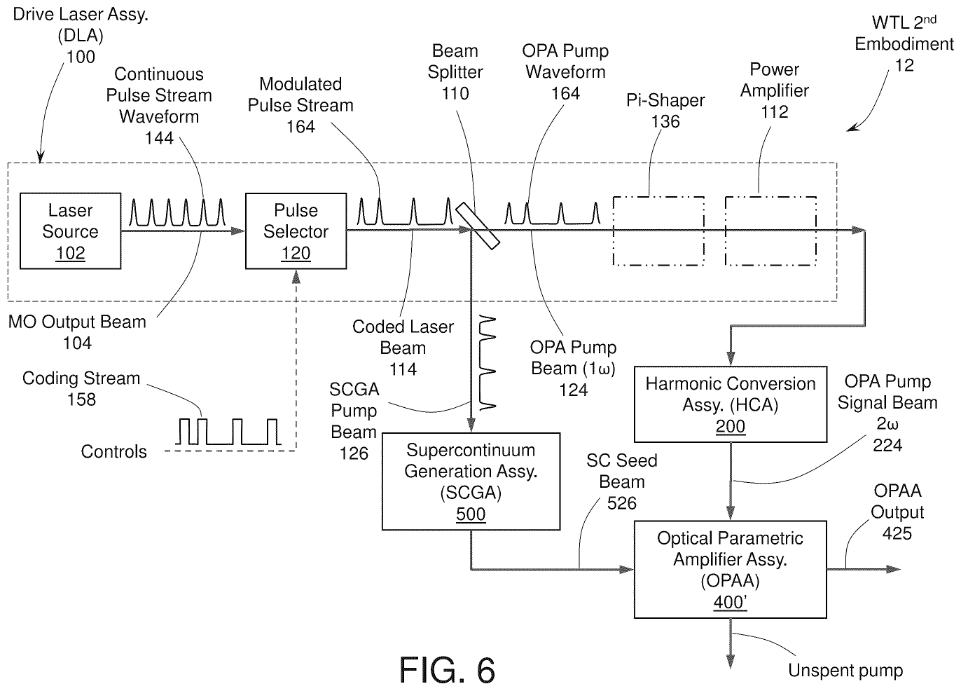

A second embodiment of the WTL of the subject invention is similar to the first embodiment except that the OPA pump beam is now frequency doubled to wavelength 2ω prior to delivery to the OPAA. Referring now to FIG. 6, there is shown a wavelength-tunable laser (WTL) 12 in accordance with a second preferred embodiment of the present invention. The WTL 12 generally comprises a drive laser assembly (DLA) 100, supercontinuum generation assembly (SCGA) 500, optical parametric amplifier assembly (OPAA) 400′, and the harmonic conversion assembly (HCA) 200. The DLA 100 and SCGA 500 may be the same as in the first embodiment WTL 11.

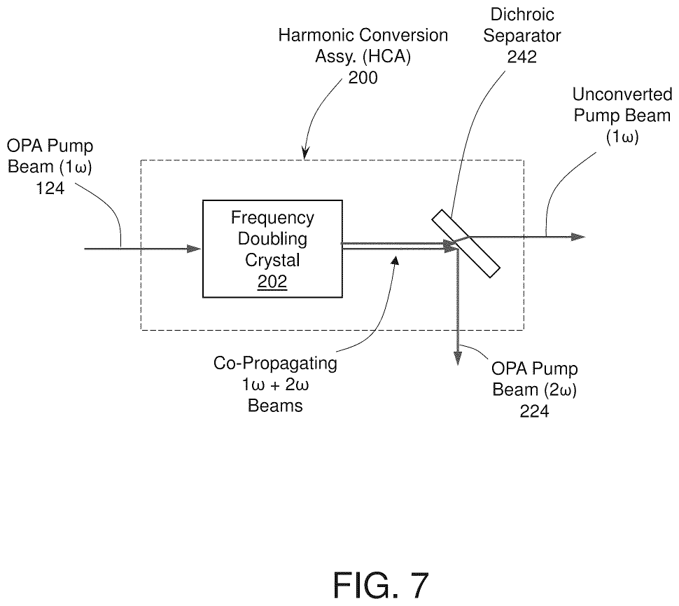

The HCA 200 shown schematically in FIG. 7 comprises a frequency doubling crystal 202 and a dichroic separator 242. The frequency doubling crystal 202 is arranged to convert a portion (preferably at least 60%) of the pulse energy in the input pump beam 124 at the wavelength 1ω into the wavelength 2ω, thereby forming an OPA pump beam 224. The 2ω beam co-propagates with the residual (unconverted) 1ω beam to the dichroic separator 242 where the unconverted 1ω beam is separated. If the 1ω wavelength is about 1 μm, suitable frequency doubling crystals in this case include beta barium borate (β-BaB₂O₄) also known as β-BBO, lithium triborate (LiB₃O₅) also known as LBO, and potassium titanyl phosphate (KTiOPO₄) also known as KTP. Suitable crystals are commercially available from numerous suppliers worldwide including Coherent NA Inc. in Plymouth, MI, Eksma Optics USA dba as Altos Photonics in Bozeman, MT, and others. The dichroic separator 242 is preferably equipped with a coating that is highly reflective at the 2ω wavelength and highly transmissive at the 1ω wavelength. The separated unconverted 1ω beam may be directed to a beam dump (not shown).

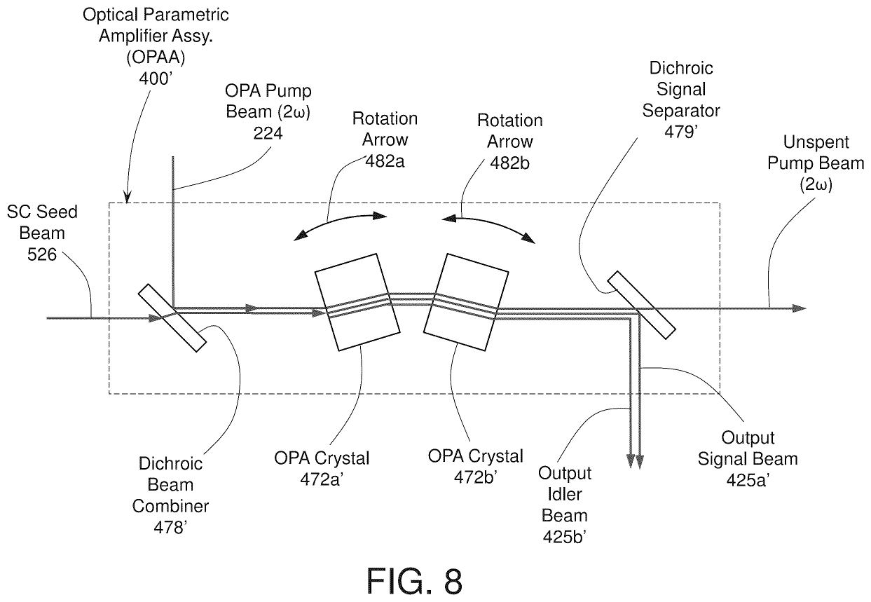

The OPAA 400′ schematically shown in FIG. 8 is structurally the same as the OPAA 400 but its components are adapted to also handle the laser light at the 2ω wavelength. If the 1ω wavelength is about 1 μm, suitable non-linear crystals 472a′ and 472b′ may be made of beta barium borate (β-BaB₂O₄) also known as β-BBO. The non-linear crystal facets that transmit the SC seed beam 526 and the OPA pump beam 224 are equipped with a coating that is antireflective at 515 nm (pump wavelength corresponding to 2ω ) and at the anticipated OPA signal band 650-900 nm and idler band 1125-2150 nm. The dichroic beam combiner 478′ is preferably equipped with a coating that is highly reflective at 515 nm (2ω pump wavelength) and antireflective at the anticipated signal and idler wavelengths. The dichroic beam separator 479′ is preferably equipped with a coating that is highly transmissive at 515 nm (2ω pump wavelength) and highly reflective at the anticipated OPA signal and idler bands. An additional dichroic may be used to separate the signal and idler outputs (not shown). This embodiment allows for the generation of coherent output in the signal beam 425a′ over the range of approximately 650-900 nm in the NIR and coherent output in the idler beam 425b′ over the range of approximately 1125-2150 nm in the NIR.

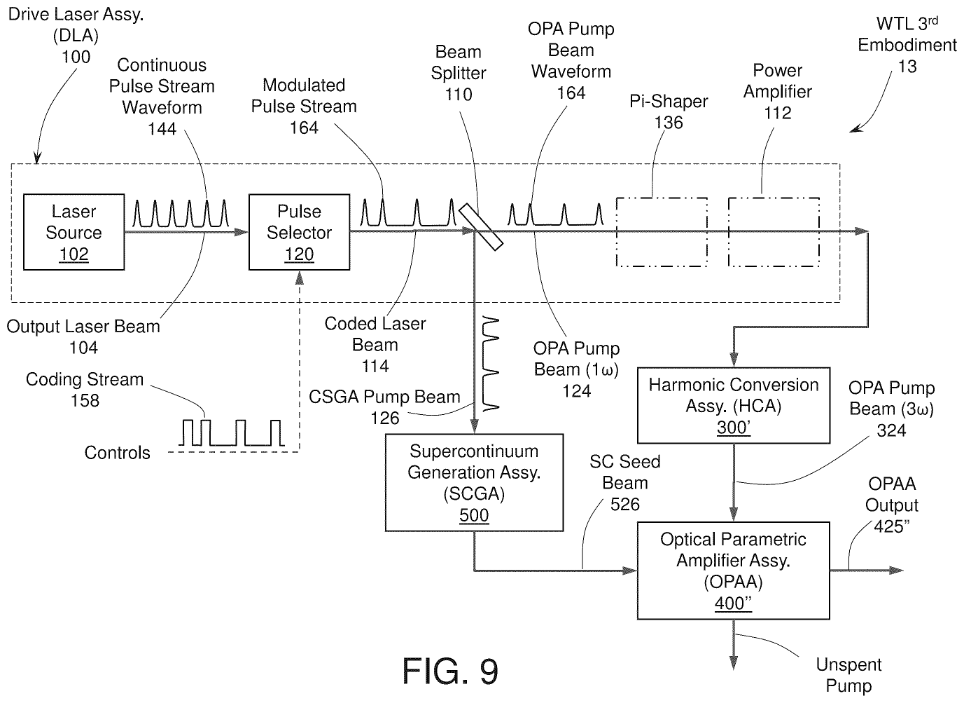

A third embodiment of the WTL of the subject invention is similar to the first embodiment except that the OPA pump beam is frequency tripled to 3ω wavelength prior to delivery to the OPAA. Referring now to FIG. 9, there is shown a wavelength-tunable laser (WTL) 13 in accordance with the third preferred embodiment of the present invention. The WTL 13 generally comprises a drive laser assembly (DLA) 100, supercontinuum generation assembly (SCGA) 500, optical parametric amplifier assembly (OPAA) 400″, and the harmonic conversion assembly (HCA) 300. The DLA 100 and SCGA 500 may be the same as in the first embodiment WTL 11.

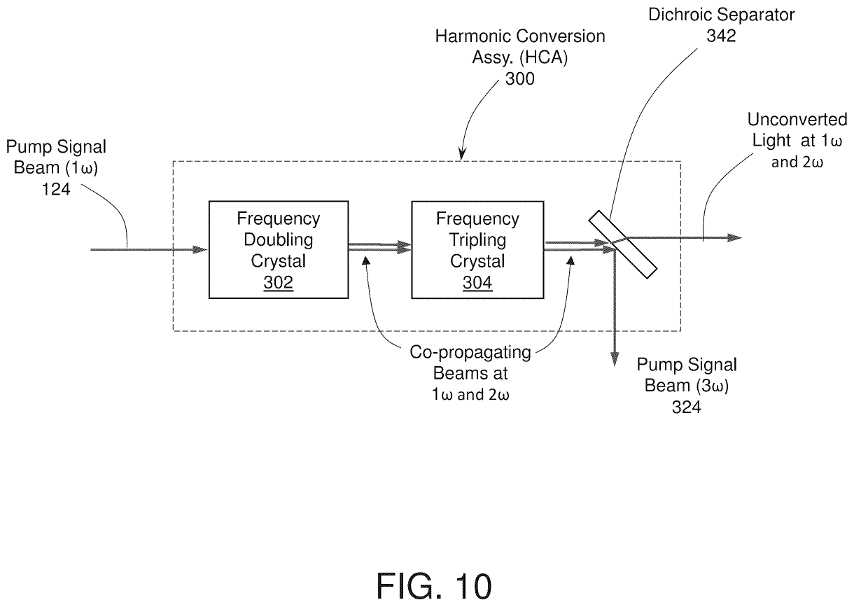

The HCA 300 shown in FIG. 10 comprises a frequency doubling crystal 302, a frequency tripling crystal 304, and a dichroic separator 342. The frequency doubling crystal 302 is arranged to convert a portion (preferably at least 50%) of the pulse energy (at wavelength 1ω) in the OPA pump beam 124 at the wavelength 1ω into the wavelength 2ω . The 2ω beam co-propagates with the residual (unconverted) 1ω beam to the frequency tripling crystal 304.

The frequency tripling crystal 304 then mixes the 2ω beam with the residual 1 beam to generate the third harmonic beam 324 at the wavelength 3ω. Under optimized conditions, a conversion efficiency of more than 50% from wavelength 1ω to wavelength 3ω can be achieved. For example, if the drive laser assembly 100 delivers to the HCA 300 a pump beam 124 at a fixed 1030 nm wavelength (1ω) with 100 μJ pulses, the third harmonic beam 324 at 3ω would have a wavelength 3ω at 343.33 nm with about with 50 μJ pulses. Suitable frequency tripling crystals include β-BBO, LBO, and KTP. The dichroic separator 342 has a coating that is highly reflective at the 3ω wavelength and highly transmissive at the 1ω and 2ω wavelengths. The dichroic separator 342 is positioned at an angle downstream of the frequency tripling crystal 304 and it separates the 3ω OPA pump beam 324 from the unconverted 1ω and 2ω light. The separated OPA pump beam 324 at the wavelength 3ω is then provided as a pump to the OPAA 400″. The separated unconverted 1ω and 2ω light may be directed to a beam dump (not shown).

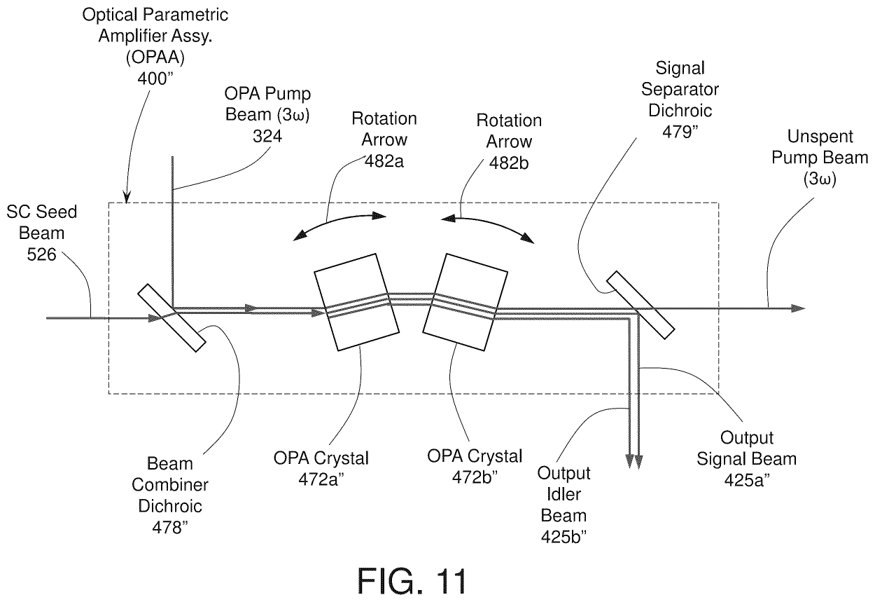

Referring to FIG. 11, OPAA 400″ is structurally same as the OPAA 400′ but its components are adapted to also handle the laser light at the 3ω wavelength. If the 1ωwavelength is about 1 μm, suitable non-linear crystals 472a″ and 472b″ may be made of β-BBO. The non-linear crystal facets that transmit the SC seed beam 526 and the OPA pump beam 324 are equipped with a coating that is antireflective at 343 nm (pump wavelength corresponding to 3ω), and at the anticipated OPA signal band 480-640 nm and idler band 740-832 nm. The dichroic beam combiner 478″ is preferably equipped with a coating that is highly reflective at 343 nm (3ω pump wavelength) and antireflective at the anticipated signal and idler wavelengths. The dichroic beam separator 479″ is preferably equipped with a coating that is highly transmissive at 343 nm (3ω pump wavelength) and highly reflective at the anticipated OPA signal and idler bands. An additional dichroic (not shown) may be used to separate the signal and idler output beams 425a″ and 425b″.

This embodiment allows for the generation of coherent output in the signal beam 425a″ over the range of approximately 470-650 nm in the VIS and the idler beam 425b″ over the range of approximately 740-832 nm in the NIR.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” and “includes” and/or “including” when used in this specification, specify the presence of stated features, integers, steps, operations, elements, and/or components, but do not preclude the presence or addition of one or more other features, integers, steps, operations, elements, components, and/or groups thereof.

The terms of degree such as “substantially”, “about”, “near-” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

The term “suitable,” as used herein, means having characteristics that are sufficient to produce a desired result. Suitability for the intended purpose can be determined by one of ordinary skill in the art using only routine experimentation.

Moreover, terms that are expressed as “means-plus function” in the claims should include any structure that can be utilized to carry out the function of that part of the present invention. In addition, the term “configured” as used herein to describe a component, section or part of a device includes hardware and/or software that is constructed and/or programmed to carry out the desired function.

Different aspects of the invention may be combined in any suitable way.

While only selected embodiments have been chosen to illustrate the present invention, it will be apparent to those skilled in the art from this disclosure that various changes and modifications can be made herein without departing from the scope of the present invention as defined in the appended claims. Furthermore, the foregoing description of the embodiments according to the present invention are provided for illustration only, and not for the purpose of limiting the present invention as defined by the appended claims and their equivalents. Thus, the scope of the present invention is not limited to the disclosed embodiments.

What is claimed is:

1. A wavelength-tunable laser comprising a drive laser assembly (DLA), supercontinuum generation assembly (SCGA), and optical parametric amplifier assembly (OPAA);
a) said DLA comprising a beam splitter;
b) said OPAA comprising at least one optical parametric amplification (OPA) non-linear crystal;
c) said DLA being arranged to produce an output laser beam at fundamental wavelength 1ω;
d) said output laser beam at fundamental wavelength 1ω being formed as a stream of pulses;
e) said beam splitter being arranged for generating from said output laser beam at fundamental wavelength 1ω (i) an SCGA pump beam and (ii) an OPA pump beam;
f) said SCGA being arranged to produce supercontinuum (SC) seed beam from said SCGA pump beam;
g) said OPA non-linear crystal being arranged for receiving said SC seed beam and said OPA pump beam;
h) said OPA non-linear crystal being positioned so that a phase matching condition is established between a predetermined spectral portion of said SC seed beam spectrum and said OPA pump beam; and
i) said OPA non-linear crystal being arranged to amplify (i) said spectral band and (ii) an OPA idler beam.

2. The wavelength-tunable laser system of claim 1, wherein said fundamental wavelength 1ω is selected from the group consisting of near-1 μm wavelength, 1030 nm wavelength, 1064 nm wavelength, near-1.9 μm wavelength, near-2 μm wavelength, and near-2.1 μm wavelength.

3. The wavelength-tunable laser system of claim 1 further comprising a harmonic conversion assembly (HCA) being arranged to harmonically convert a portion of said output laser beam at fundamental wavelength 1ω into a laser beam at wavelength 2ω prior to said OPA pump beam being received by said OPA non-linear crystal.

4. The wavelength-tunable laser system of claim 1 further comprising a harmonic conversion assembly (HCA) being arranged to harmonically convert a portion of said output laser beam at fundamental wavelength 1ω into a laser beam at wavelength 3ω prior to said OPA pump beam being received by said OPA non-linear crystal.

5. The wavelength-tunable laser system of claim 1, wherein said output laser beam produced by said DLA is further modulated in accordance with a coding stream.

6. The wavelength-tunable laser system of claim 1, wherein said SCGA comprises a photonic crystal fiber (PCF).

7. The wavelength-tunable laser system of claim 1, wherein said OPA non-linear crystal is arranged to rotate so that said phase matching condition is established between different spectral bands of said SC seed beam and said OPA pump beam.

8. The wavelength-tunable laser system of claim 1 further including a means for synchronizing the pulses in said SC seed beam and said OPA pump beam within said OPAA.

9. The wavelength-tunable laser system of claim 1, wherein said OPA non-linear crystal is being arranged to amplify an OPA idler beam.

10. The wavelength-tuneable laser system of claim 1, further comprising a delay line for synchronizing the arrival of pulses in said SC beam and said OPA pump beam to said OPAA.

11. The wavelength-tunable laser system of claim 1, wherein said DLA further comprises a power amplifier for boosting the pulse energy of said output laser beam at fundamental wavelength 1ω.

12. A wavelength-tunable laser comprising a drive laser assembly (DLA), supercontinuum generation assembly (SCGA), and optical parametric amplifier assembly (OPAA);
a) said DLA comprising a beam splitter;
b) said OPAA comprising at least one OPA non-linear crystal;
c) said DLA being arranged to produce an output laser beam at fundamental wavelength 1ω formed as a stream of pulses;
d) said beam splitter being arranged for generating from said output laser beam (i) a first pump beam and (ii) a second pump beam;
e) said first pump beam being directed to pump the SCGA;
f) said SCGA arranged to produce a supercontinuum (SC) seed beam from said first pump beam;
g) said SC seed beam comprising a plurality of spectral bands;
h) said OPA non-linear crystal being arranged for receiving said SC seed beam and an OPA pump beam;
i) said OPA pump beam being formed by an action selected from the group consisting of 1) using the second pump beam at the 1ω wavelength, 2) harmonically converting a portion of said second pump beam to a 2ω wavelength prior to arriving at said OPA non-linear crystal, and 3) harmonically converting a portion of said second pump beam to a 3ω wavelength prior to arriving at said OPA non-linear crystal;
j) said OPA non-linear crystal being positioned so that a phase matching condition is established between a spectral band of said SC seed and said OPA pump beam; and
k) said OPA non-linear crystal being arranged to amplify said spectral band.

13. The wavelength-tunable laser of claim 12, wherein said OPA non-linear crystal is being arranged to amplify an OPA idler beam.

14. A wavelength-tunable laser comprising a laser source, photonic crystal fiber (PCF) adapted for generation of supercontinuum (SC) output, a beam splitter, and non-linear (NL) crystal suitable for optical parametric amplification (OPA);
a) said laser source being arranged to produce an output laser beam at fundamental wavelength 1ω;
b) said output laser beam formed as a stream of pulses;
c) said beam splitter being arranged for generating from said output laser beam (i) a first pump beam and (ii) a second pump;
d) said PCF being arranged to produce a SC seed beam from said first pump beam;
e) said second pump beam being routed to said NL crystal;
f) said NL crystal being arranged for receiving said SC seed beam and said second pump beam;
g) said NL crystal being positioned so that a phase matching condition is established between a spectral band of said SC seed beam and said second pump beam; and
h) said NL crystal being arranged to amplify said spectral band.

15. The wavelength-tunable laser system of claim 14, wherein said NL crystal is being arranged to amplify an OPA idler beam.

16. The wavelength-tunable laser system of claim 14, wherein at least a portion of said second pump beam is harmonically converted to wavelength 2ω prior to the second pump beam being routed to said NL crystal.

17. The wavelength-tunable laser system of claim 14, wherein at least a portion of said second pump beam is harmonically converted to wavelength 3ω prior to the second pump beam being routed to said NL crystal.

18. A method of generating coherent laser radiation that can be wavelength-tuned comprising the steps of:
a) Presenting a laser source, a photonic crystal fiber adapted for the generation of supercontinuum (SC) output, and a non-linear crystal adapted for optical parametric amplification;
b) Generating in said laser source an output laser beam at a fundamental wavelength 1ω;
c) Arranging said output laser beam as a stream of pulses;
d) Splitting said output laser beam into (i) a first pump beam and (ii) a second pump beam;
e) Feeding said first pump beam to said photonic crystal fiber;
f) Generating an SC seed beam in said photonic crystal fiber;
g) Feeding said second pump beam to said non-linear crystal;
h) Feeding said SC seed to said non-linear crystal;
i) Substantially co-aligning said SC beam and said second pump beam to overlap in the transverse direction;
j) Synchronizing the pulses in said second pump beam and said SC seed beam so that pulses overlap in time;
k) Arranging said non-linear crystal to phase match said second pump beam and a spectral band of said SC seed beam; and
l) Amplifying said spectral band of said SC seed beam;

19. The method of generating coherent laser radiation that can be wavelength-tuned of claim 18 further comprising the step of:
(a) Rotating said non-linear crystal to tune the center wavelength of said SC spectral band and an idler beam.

20. The method of generating coherent laser radiation that can be wavelength-tuned of claim 18 further comprising the steps of:
(a) Amplifying an OPA idler beam.

21. The method of generating coherent laser radiation that can be wavelength-tuned of claim 18 further comprising the steps of:
(a) Harmonically converting said second pump beam to wavelength 2ω prior to feeding said second pump beam to said non-linear crystal.

22. The method of generating coherent laser radiation that can be wavelength-tuned of claim 18 further comprising the steps of:
(a) Harmonically converting said second pump beam to wavelength 3ω prior to feeding said second pump beam to said non-linear crystal.

23. A method of generating coherent laser radiation that can be wavelength-tuned comprising the steps of
a) Presenting a drive laser assembly (DLA), supercontinuum generation assembly (SCGA), and an optical parametric amplifier assembly (OPAA);
b) Presenting a non-linear (NL) crystal within the OPAA adapted for optical parametric amplification.
c) Generating in said DLA a 1ω laser beam formed as a stream of pulses;
d) Splitting of the 1ω laser beam into (i) a first pump beam and (ii) a second pump beam;
e) Feeding said seed first pump beam to said SCGA and generating a supercontinuum (SC) seed beam;
f) Feeding said second pump signal beam to said OPAA;
g) Feeding said SC seed beam to said OPAA;
h) Arranging said second pump signal beam and said SC seed beam to be collinear;
i) Synchronizing the pulses in said second pump beam and said SC seed beam;
j) Arranging said NL crystal to phase match said second pump beam and a spectral band of said SC seed beam;
k) Amplifying a spectral band of said SC seed beam and an idler beam;
l) Rotating said NL crystal to tune the center wavelength of said spectral band and an idler beam.
